(19) United States
(12) Patent Application Publication
(10) Pub. No.: US 2010/0226711 A1
(43) Pub. Date: Sep. 9, 2010

(54) JOINING DEVICE FOR TWO BAR-TYPE HOLLOW PROFILED MEMBERS, AND METHOD FOR THE PRODUCTION THEREOF

(76) Inventor: Winfried K.W. Holscher, Engen (DE)

Correspondence Address: BACHMAN & LAPOINTE, P.C., 900 CHAPEL STREET, SUITE 1201, NEW HAVEN, CT, 06510, US

(21) Appl. No.: 12/779,738

(22) Filed: May 13, 2010

Related U.S. Application Data
(62) Division of application No. 10/549,789, filed on Sep. 19, 2005.

(30) Foreign Application Priority Data
Jan. 22, 2004 (DE) 20 2004 000 978.1
Jun. 25, 2004 (DE) 10 2004 031 038.6
Sep. 29, 2004 (DE) 20 2004 015 101.4

(51) Int. Cl. F16B 7/04

(52) U.S. Cl. 403/264

(57) ABSTRACT

In a connecting device for connecting a first extruded hollow profile (10), having a profile channel and at least one undercut groove space on a longitudinal groove (20), to another such workpiece by a screw element or other member which passes through an opening (20) in the workpiece and can be inserted into the interior (22) of the other workpiece, there is fixed to the end face (14) of the hollow profile (10) a strip-like socket profile (34) which runs radially with respect to the profile channel (12) and has at least at one end a stepped face (35) for receiving the screw element, which screw element in the rest position lies inside the side contours of the socket profile (34) and in the connecting position projects beyond the socket profile at least on one side and engages in a retaining manner in the undercut space of the other hollow profile (10).

### CROSS REFERENCE TO RELATED APPLICATIONS

This application is the U.S. divisional application of U.S. application Ser. No. 10/549,789 filed Jun. 19, 2005.

### BACKGROUND OF THE INVENTION

The invention relates to a connecting device for connecting a first extruded hollow profile—having a profile channel and at least one undercut groove space on a longitudinal groove—to another workpiece by means of a screw element or other connecting member. The invention also relates to a method for producing the device.

DE 92 15 843 by the Applicant describes a connecting device for fixing in an undercut interior of a longitudinal groove of a hollow profile or other workpiece, with at least one dimension which exceeds the width of the narrow groove cross section for connecting a first workpiece, having the longitudinal grooves, to another workpiece, which is in turn provided with longitudinal grooves, the cross section of which opens towards the profile end face. This element is used in particular in the case of metallic hollow profiles, the interior of which is not accessible from outside; it is approximately square-shaped and has at least two opposite side walls which are inclined at an angle and also a spring member which at one end is fixed to one of the inclined side walls and at the other end engages with its free end over the narrower surface of the element. The latter is arranged at a distance from the element in the non-tensioned state of the spring. When the spring member is pressed against the nut element, the latter can readily be pushed—with its narrow side first—into the undercut groove.

In another connecting member for fixing in an undercut groove space of a longitudinal groove of a hollow profile according to DE 198 40 057 A1 by the Applicant and for connecting the hollow profile to another workpiece which is in turn provided with corresponding longitudinal grooves, in each case at least one shaped portion which corresponds approximately to the width of a longitudinal groove forming the narrow groove cross section is provided on the surface of angled arms of an angled shaped piece as a fixing or connecting device, and there is fixed in the angled arm at least one screw which passes through said angled arm; the width of the angled arm exceeds the width of the longitudinal groove. Moreover, the cross section of the shaped portion tapers away from the surface of the angled arm.

Knowing these conditions, the inventor set himself the aim of providing an operationally reliable possibility for fixing in particular extruded hollow profiles of polygonal—preferably rectangular—cross section which are to be connected to one another, especially at approximately right angles. In particular, a system is to be improved in which the profile end face of one workpiece bears against a longitudinal side of the other workpiece and is held thereon—as far as possible in a manner secured against twisting. Another aim of the inventor is to considerably simplify the connection procedure per se and above all to improve the handling of the connecting member by configuring the latter as one unit.

### SUMMARY OF THE INVENTION

According to the invention, there is fixed to a hollow profile a strip-like socket profile which runs radially with respect to the longitudinal axis of the profile channel and has at least at one end a stepped face for receiving the screw element, which screw element in the rest position lies inside the side contours of the socket profile and in the connecting position projects beyond said socket profile at least on one side and engages in a retaining manner in the undercut space of the groove space of the other hollow profile. The socket profile is preferably fixed to the end face of the hollow profile.

It has proven advantageous to provide the socket profile with a baseplate on a head strip which is of shorter length in longitudinal section than the length of the baseplate, so that part of the latter projects beyond the end side(s) of the head strip to form its surface as a stepped face.

According to another feature of the invention, the screw element has a socket strip which is essentially rectangular in plan view, from the surface of which socket strip there projects a screw sleeve or socket sleeve for a screw passing axially through it, in particular for an Allen screw. The outer contour of this screw sleeve or socket sleeve is intended to have two corner edges which are arranged diagonally with respect to its interior and preferably issue from a longitudinal edge of the socket strip, from which corner edges a flat wall surface projects on either side as part of the sleeve wall; the latter merges into an arced area of the sleeve wall which is curved in cross section. This shaping improves the rotatability of the screw element when the latter is inserted in a longitudinal groove of a hollow profile.

Advantageously, the socket strip projects beyond the sleeve wall in its longitudinal axis. The corner regions of this socket strip may be shaped as a segment of a circle in plan view, and a rounded corner region of the socket strip may be assigned to the corner edge of the sleeve wall. The socket profile is moreover intended to be passed through by an opening for a screw member, said opening being arranged approximately in the centre of its head strip, which screw member can be fixed in the profile channel of the hollow profile, the end face of which is intended to bear against the front face of the socket profile.

It is within the scope of the invention that an upper or stepped face of the socket profile—or the two such faces thereof—run(s) at a distance from the end face of the hollow profile, which distance corresponds to the height of the end side of the head strip and/or to the sum of the thickness of shaped ribs—which cover the undercut space and delimit the longitudinal groove—and the thickness of the socket strip.

It is moreover important according to the invention that the longitudinal axis of the socket strip of the screw member runs parallel to the longitudinal axis of the hollow profile in the inserted position and the socket strip is arranged such that it can be displaced in the longitudinal groove. According to the invention, in order to connect the two hollow profiles, the screw members of shaped ribs which in the connecting position cover the undercut space of one hollow profile are gripped from below in each case by the socket strips of said screw members, as a result of which the shaped ribs of one hollow profile are held firmly against the end face of the other hollow profile. In the connecting position the longitudinal axis of the socket strip is then transverse to the longitudinal axis of the associated hollow profile.

In the context of the invention, there is to be used as the connecting element a sleeve which is inserted in the longitudinal groove, said sleeve having lateral outer ribs which can be inserted in radial grooves of the hollow profile. The sleeve is assigned a clamping screw which can be inserted coaxially into the sleeve interior, said sleeve interior optionally partially being provided with a polygonal cross section; the clamping screw is held by its sleeve on the hollow profile.

The outer rib, which is approximately triangular in cross section at least in its free end region, merges with its rib faces into shaped channels of the sleeve peripheral surface, and the two rib faces preferably merge into a rib crest which may be designed as a sharp edge.

Preferably, the outer rib has at one end a side edge which forms an angle of approximately 45° with a radial line placed approximately through the centre of the outer rib; the outer rib is upset at its inclined side edge.

This sleeve has at least three groups of outer ribs which are parallel to its centre axis and are assigned to radial grooves in the fixing position; said radial grooves are formed in the groove bottom of the longitudinal groove of the hollow profile and also in facing surfaces of shaped ribs which delimit the longitudinal groove on the profile side face. It has proven advantageous if the side edges of a group of outer ribs are aligned with one another parallel to the centre axis. The inclined side edge of the outer rib advantageously forms a contact resistance between the sleeve and the associated radial grooves, which allows insertion of the outer ribs.

The design of the abovementioned sleeve and its cooperation with the clamping screw assigned to it is of critical importance to the invention; the sleeve which is inserted in the longitudinal groove is—as has already been mentioned—provided with lateral outer ribs which project from its peripheral surface, said ribs being designed such that they can be inserted in radial grooves of the hollow profile. Moreover, the sleeve is assigned a clamping screw which can be inserted into its interior, with a round shaft being integrally formed on the screw head of said clamping screw. The round shaft merges into a coaxial screw shaft at a distance from the screw head.

A shaft which is integrally formed on a screw head of the clamping screw and which is provided with the thread at a distance from the screw head has proven advantageous. A round portion of the shaft extends between the screw head and the thread, the length of which round portion corresponds approximately to two-thirds of the shaft length.

Moreover, for the sake of better fixing, the external diameter of the thread or of the screw shaft should be greater than the diameter of the sleeve interior or of an opening in a rear wall of the sleeve which delimits the sleeve interior and is passed through by the shaft. Since, according to the invention, the thread on the shaft forms an annular edge which faces towards the screw head, the latter serves as a stop member, the partner of which is the annular rear wall of the sleeve. According to a further feature of the invention, the clamping screw is arranged such that it can be displaced axially in the sleeve between its screw head and the annular edge; when the screw head of the clamping screw bears against the associated outer sleeve edge of the sleeve, the thread projects from the sleeve at the other end.

Advantageously, a longitudinal portion of the interior of the sleeve should be designed as a polygonal cross section—in particular as a hexagonal cross section—and should bear against a cylindrical portion of the sleeve interior, the axis-parallel edges of said polygonal cross section being designed as notched channels.

Advantageously, the axial length of the cylindrical portion of the sleeve interior corresponds approximately to the length of the thread of the clamping screw.

It is also within the scope of the invention that an axial collar is integrally formed on the sleeve at its end remote from the rear wall, and the shaft can be displaced within said collar. This collar together with the peripheral surface of the sleeve delimits an annular zone of this sleeve, and moreover the height of the collar extends the contact length between sleeve and clamping screw. The preferred contact length is approximately 20.5 mm.

According to the invention, the outer rib, which is approximately triangular in cross section at least in its free end region, merges with its lateral rib faces into shaped channels of the sleeve peripheral surface. The two rib faces merge into a rib crest which is preferably designed as a sharp edge.

Preferably, the outer rib has at one end a side edge which forms an angle of approximately 45° with a radial line placed approximately through the centre of the outer rib; the outer rib is upset at its inclined side edge.

Furthermore, a plate-like, flat, square body may be provided on a side edge of the outer rib in order to improve the seating position of the sleeve. This plate-like body engages axially over the outer ribs on their rib face remote from the collar. The inclined side edge of the outer rib forms a contact resistance between the sleeve and the associated radial grooves. The latter are formed in the groove bottom of the longitudinal groove of the hollow profile and also in facing surfaces of shaped ribs which delimit the longitudinal groove on the profile side face.

Also within the scope of the invention is a method for producing the described device, in which the sleeve is pushed onto the round shaft of the clamping screw and the free end of the round shaft which projects coaxially from the sleeve interior is shaped to form a thread. This takes place in particular by means of rolling-shaping.

### BRIEF DESCRIPTION OF THE DRAWINGS

Further advantages, features and details of the invention emerge from the following description of preferred examples of embodiments and with reference to the drawing, in which:

FIG. 1 shows the front view of an extruded hollow profile having longitudinal grooves, with connecting members for a second hollow profile of identical shape which is placed on the first hollow profile at right angles, said connecting members being pushed into two of the longitudinal grooves;

FIG. 2 shows an exploded side view of a portion of the hollow profile in combination with an associated socket profile as part of a connecting member, said socket profile being shown in section;

FIG. 3 shows the socket profile of FIG. 2 on a smaller scale;

FIG. 4 shows an enlarged detail from FIGS. 3 and 14, at the arrow IV therein;

FIG. 5 shows the plan view of the socket profile;

FIG. 6 shows an oblique view of the socket profile;

FIGS. 7, 8 show a plan view and a side view of a screw element for the socket profile;

FIG. 9 shows the plan view of a different embodiment of the screw element;

FIG. 10 shows the front view of part of a hollow profile with the side view of an associated other hollow profile during the introduction of a screw element;

FIG. 11 shows the hollow profiles of FIG. 10 in the position where they are fixed to one another;

FIG. 12 shows an oblique view of a different embodiment of the socket profile;

FIG. 13 shows the plan view of the socket profile of FIG. 12;

FIG. 14 shows the longitudinal section through FIG. 13 along the line XIV-XIV therein;

FIG. 15 shows the front view of another hollow profile with an integrated connecting element;

FIG. 16 shows a side view of the partially cut-away hollow profile of FIG. 15;

FIG. 17 shows an enlarged plan view of the connecting element of FIG. 15;

FIG. 18 shows part of the connecting element in an enlarged and partially cut-away side view;

FIG. 19 shows an enlarged detail from FIG. 18;

FIG. 20 shows a side view of a sleeve with a clamping screw associated axially therewith;

FIG. 21 shows the partially cut-away pairing of FIG. 20 in a different operating position;

FIG. 22 shows an oblique view of the sleeve of FIGS. 20, 21;

FIG. 23 shows a front view of FIG. 22;

FIG. 24 shows an enlarged detail of FIGS. 20, 29 at the part XXIV therein;

FIGS. 25, 27 each show a diagram of a differently configured sleeve, corresponding more or less to the diagram in FIG. 22;

FIG. 26 shows a longitudinal section through the sleeve of FIG. 25 with an associated clamping screw;

FIG. 28 shows a front view of FIG. 27;

FIG. 29 shows a diagram of the sleeve of FIG. 27 with a clamping screw associated axially therewith, said diagram corresponding to that of FIG. 20;

FIGS. 30, 31 each show the partially cut-away pairing of FIG. 29 in a different operating position;

FIG. 32 shows a cut-away region of FIG. 22 in a different embodiment;

FIG. 33 shows an enlarged oblique view of a detail of the sleeve of FIG. 32.

### DETAILED DESCRIPTION

A hollow profile 10 of square cross section having an outer side length a of in this case 45 mm with cross-sectional axes B, B₁ as axes of symmetry, said cross-sectional axes being placed through the centre Z of its end face 14 (the centre Z being defined by a profile channel 12 running in the profile longitudinal axis A), has a central column 11 of square cross section which contains the profile channel 12 and also, in each case in the centre of its profile side faces 16, a longitudinal groove 20 of width b of for example 12 mm, said longitudinal groove being delimited on either side by shaped ribs 18 of thickness c of in this case 6 mm and merging towards the profile longitudinal axis A into a groove space 22 which is undercut in cross section. The shaped ribs 18 are provided with corner cut-outs 17 on the profile side face 16.

The undercut space or groove space 22 is delimited towards the centre Z of the end face by a bottom or groove bottom 24 and is shaped as a channel-like recess which is covered by said shaped ribs 18, the channel-like recess having a height e of approximately 8 mm and a maximum width f of approximately 20 mm. The free end of each of the channel-like recesses forms a hexagonal end opening 25 in the end face 14 of the hollow profile 10, and the longitudinal groove 20 forms an elongate opening in the profile side faces 16.

Assigned to the four outer faces of said central column 11 which form the groove bottoms 24, respectively on either side of their cross section, is an arm-like rib 26 which runs in a manner inclined at an angle of 45° with respect to the cross-sectional axes B, B₁, that is to say diagonally in the end face 14. Each of these ribs 26 formed on the central column 11 merges into one of the corner regions 28 of the hollow profile 10; in each of these corner regions 28 there is—parallel to the profile longitudinal axis A—a corner channel 30 of almost square cross section, from which there issue narrow blind slots 32 of the shaped ribs 18, which run in the latter in an axis-parallel manner.

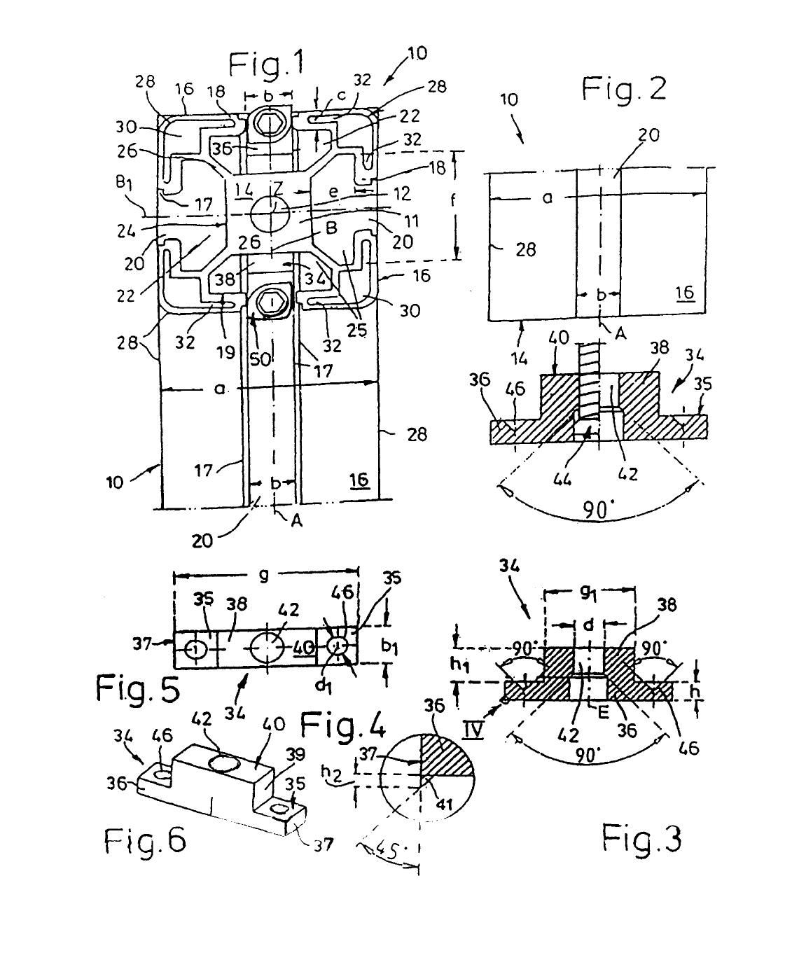

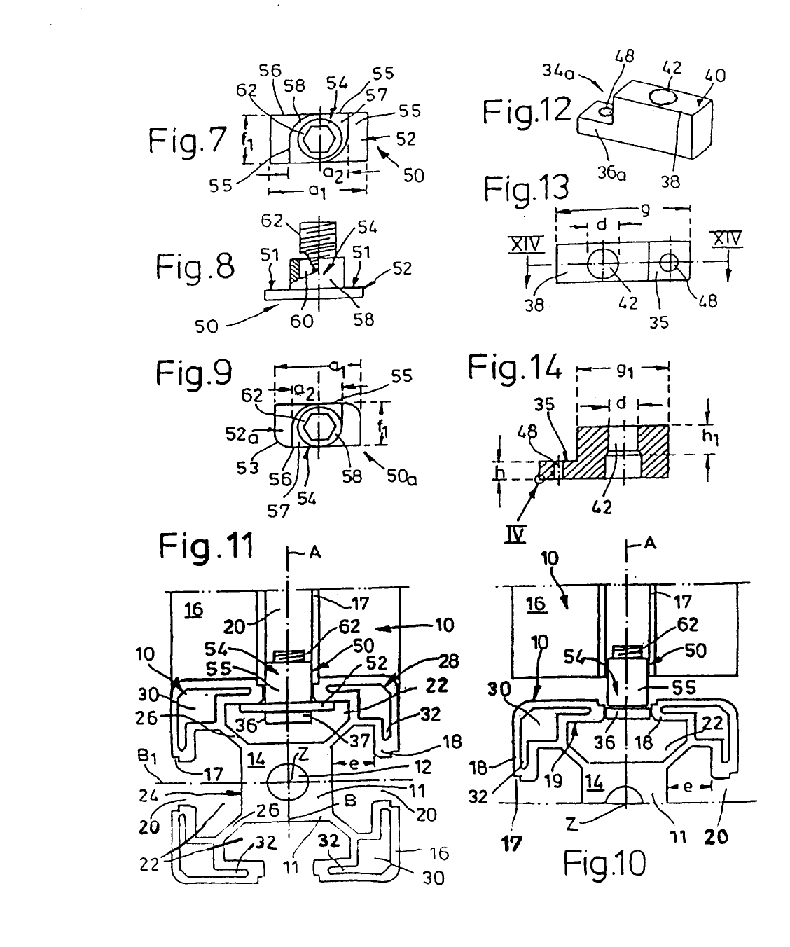

The upper hollow profile 10 in FIG. 1 is gripped from below at one of its end faces 14 by a second hollow profile 10 of identical cross section which is associated therewith at right angles, and is connected by connecting members. The two hollow profiles 10 are preferably extruded from an aluminium alloy.

In FIG. 2, one end of the upper hollow profile 10 in FIG. 1 is shown with a socket profile 34 for connecting members shown at 50 in FIG. 1, which socket profile is to be fixed to the end face 14 of the hollow profile. This socket profile 34, the longitudinal axis of which is shown at E, has a baseplate 36 having for example a length g of 44 mm, a width b₁ of 10 mm and a height h of 5 mm, on which there is integrally formed a central head strip 38 having the same width b₁, a shorter length g₁ of approximately 24 mm and a height h₁ of approximately 9 mm. The baseplate 36 respectively forms, on either side of the head strip 38 made in one piece therewith, a stepped face 35 which is parallel to its top face 40 and which adjoins the end side 39 of the head strip 38. As shown in FIG. 4, bottom strips 41 having a height h₂ of 0.3 mm which are triangular in cross section may be integrally formed on the end sides 37 of the baseplate 36.

This socket profile 34 is fixed in the profile channel 12 by means of a screw, shown at 44 in FIG. 2, which passes through a central opening 42 having a diameter d of 8 mm, in such a way that the top face 40 of the head strip 38 of the socket profile 34 bears against the end face 14 of the hollow profile 10. A depression having a diameter d₁ of 5 mm is shown at 46 on either side of the head strip 38 in the stepped or upper face 35 of the baseplate 36; screw holes 48 may also be provided instead of said depressions, as shown in FIG. 12.

When the socket profile 34 is fixed on the end face 14 of the hollow profile 10, the upper faces 35 offered by the two ends of the baseplate 36 run at a distance h₁ from the end face 14 and in each case serve to support a screw element 50, by means of which the two hollow profiles 10 lying at right angles to one another are connected.

This screw element 50, which is made of a hard metal, comprises a rectangular socket strip 52—having a length a₁ of approximately 16 mm, a thickness c₁ of approximately 3 mm and a width f₁ of approximately 9 mm—and a screw sleeve 54 which is integrally formed thereon. Said width f₁ of the socket strip 52 is also the width f₁ of the socket sleeve 54, the length a₂ of which is approximately 9 mm, that is to say corresponds to the width f₁. Between two corner edges 57 of the socket sleeve 54 which are diagonal to one another and are in each case formed by two wall surfaces 55 at the longitudinal edges 56 of the socket strip 52 which abut against one another at right angles in plan view, or between said wall surfaces 55, the outer contour of the socket sleeve 54 is shaped like a segment of a circle in a 90° arc region 58 in plan view. An Allen screw 62 is seated in the cylindrical interior 60 of the socket sleeve 52.

In the embodiment of the screw element 50ₐ which is shown in FIG. 9, two corner regions 53 of the socket strip 52ₐ are rounded and lie opposite the corner edges 57 of the screw sleeve or socket sleeve 54.

When two hollow profiles 10 are joined together, as shown in FIGS. 10, 11, the socket strip 52 of the screw element 50 or 50ₐ—which is screwed onto a stepped face 35 of the baseplate 36 of the socket profile 34 fixed on the upper hollow profile 10 in the described manner—is placed on the baseplate 36 in such a way that it does not protrude laterally, wherein the longitudinal axis of the socket strip runs parallel to the longitudinal axis A of the hollow profile 10. The screw element 50 can then be inserted into the longitudinal groove 20 of the hollow profile 10. Once the end face 14 of the other hollow profile 10 is seated on the profile side face 16 of the first hollow profile, the screw element 50 or 50ₐ is turned through 90° using an Allen key on the Allen screw 62, so that the projecting regions of the socket strip 52 or 52ₐ engage below the adjacent shaped ribs 18. By virtue of a further screwing operation, the upper faces 51 of the socket strip 52 or 52ₐ are drawn towards the lower faces 19 of the shaped ribs 18 and hold the hollow profiles 10 against one another in a clamped manner.

The socket profile 34ₐ of FIGS. 12 to 14 has a protruding region of the baseplate 36ₐ only at one end side of the head strip 38, and thus only one stepped face 35. The latter is provided with a screw hole 48 for receiving the Allen screw 62 of the screw element 50, 50ₐ which is to be placed thereon. The connection operation takes place in the manner described above by turning the stepped face 35 below the lower face 19 of a shaped rib 18 and then pressing the two faces 19, 35 against one another.

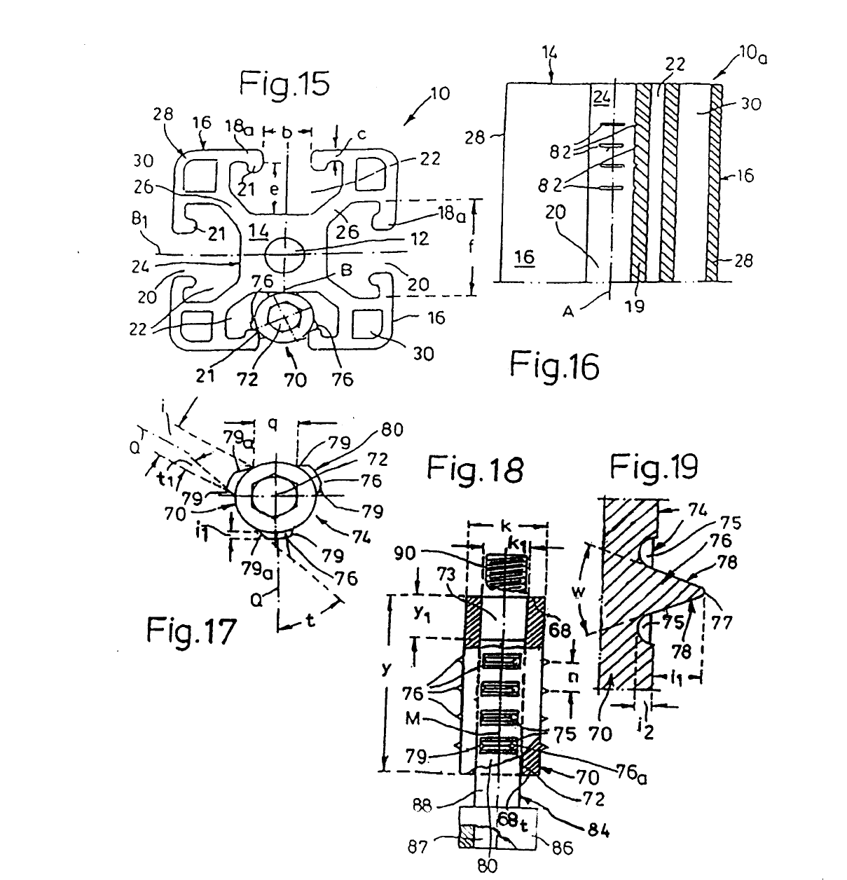

The hollow profile 10, of FIGS. 15, 16 has, on either side of the longitudinal grooves 20, shaped ribs 18ₐ which are hook-shaped in cross section. The hook ends 21 of the shaped ribs 18ₐ are oriented towards the groove bottom 24 of the undercut groove space 22. The corner channels 30 are in this case of almost square cross section.

In the undercut space 22 located at the bottom in FIG. 15, there can be seen a sleeve 70 with a cylindrical interior 72, from the peripheral surface 74 of which there project radial outer ribs 76 having a front width i of 5 mm; these form—in each case at a peripheral distance q from one another—three parallel rows of protrusions 80 which run parallel to the central axis M of the sleeve 70, each of said rows containing in this case four outer ribs 76. Said interior of the sleeve 70—having a length y of 25 mm and an external diameter k of 10.2 mm and an internal diameter k₁ of 6.0 mm—merges at the upper sleeve end into a hexagonal region 73 having an axial length y₁ of 6 mm. In the region of the cylindrical area of the sleeve interior 72, the aforementioned outer ribs 76 project from the peripheral surface 74 of the sleeve 70 with a protruding width i₁ of approximately 1 mm, at axial central spacings n of approximately 4 mm from one another.

As shown in FIG. 19, the axis-parallel section of the outer ribs 76 is triangular; the two rib faces 78 issuing from the rib crest 77 define a cross-sectional angle w of almost 45°. These rib faces 78 respectively merge into a channel 75 formed in the peripheral surface 74, said channel having a depth i₂ of 0.3 mm. As shown in FIG. 17, the two side edges 79, 79ₐ of each of the outer ribs 76—which are arranged in three axis-parallel rows or groups 80 of uniform peripheral spacing q—are inclined away from the peripheral surface 74 at different angles t and t₁ of respectively 15° and approximately 45° with respect to a radial line Q which crosses through the centre of the outer rib 76; the side edge 79 may also define an even smaller angle t₁. The upset side edge 79ₐ gives rise to a greater contact resistance upon rotation of the sleeve 70, which will be perceived by the operator during the rotation operation and will terminate the rotation operation. Moreover, the length of said peripheral spacing q corresponds approximately to that of the front width i of the outer ribs 76.

The outer ribs 76 are inserted in a rotating manner into radial grooves 82 of the groove bottom 24 and of the hook ends 21, and allow a firm seating of the sleeve 70 in the hollow profile 10ₐ.

A clamping screw 84 may be embedded in the sleeve interior 72, 73, the screw head 86 of which clamping screw has a hexagonal hole 87 for an Allen key (not shown), wherein the screw head 86 bears against the lower sleeve edge 68ₜ in the clamped position. Adjoining the screw head 86 is a round shaft 88, which merges into a screw shaft 90 as a threaded region. The latter protrudes beyond the upper sleeve edge 68 in FIG. 18.

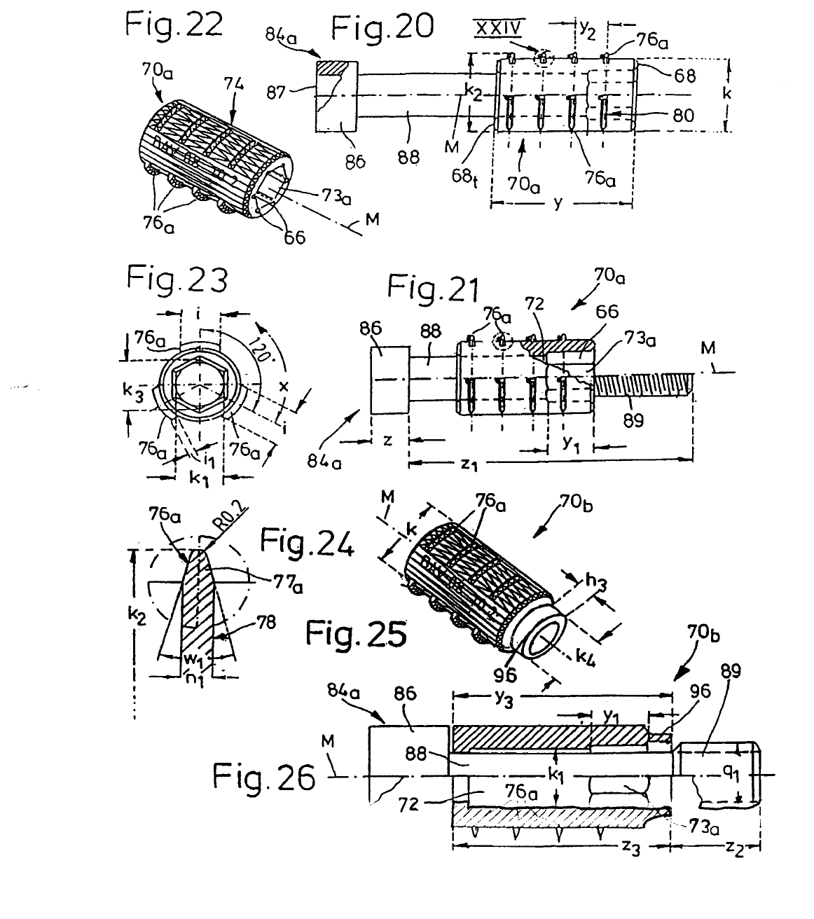

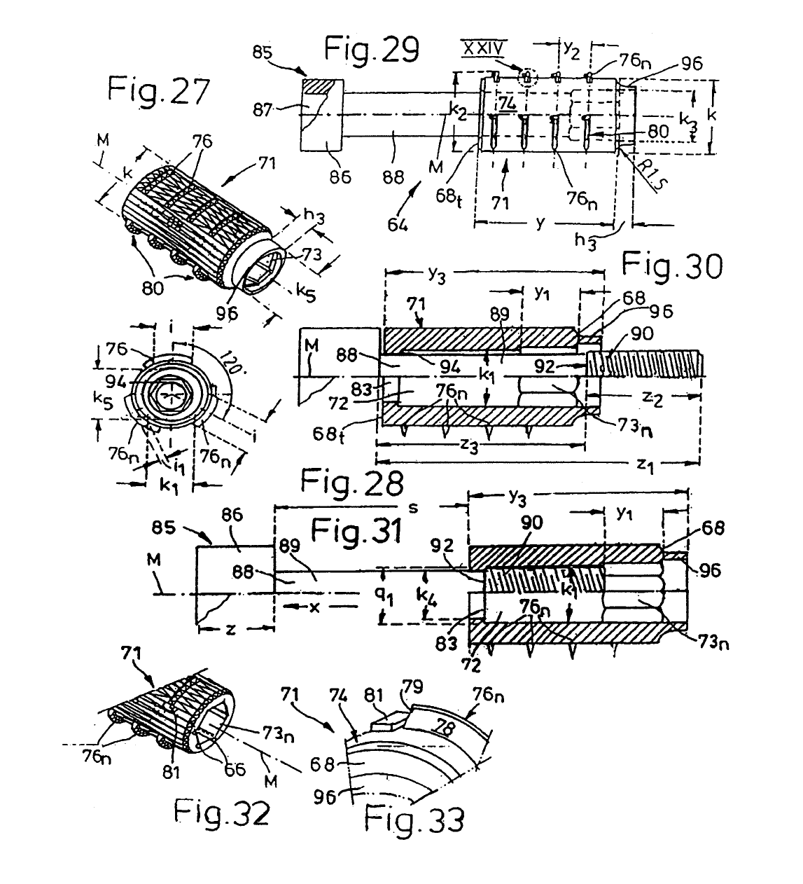

A different unit, consisting of a sleeve 70ₐ and 71 respectively—having a length y of in this case 18 mm and 20.5 mm respectively and an external diameter k of 10.2 mm—of and a clamping screw 84ₐ and 85 respectively which is inserted into said sleeve, is shown in FIGS. 20 to 24 and 27 to 31 respectively, in FIG. 29 as the connecting member 64. The sleeve 70ₐ or 71 likewise has three groups or rows 80 of in each case four outer ribs 76ₐ and 76ₙ, which define an external diameter k₂ of 12 mm and the rib crest 77 of which tapers in cross section from a rib thickness n₁ of approximately 0.8 mm at an angle w₁ of 30°, as shown in FIG. 24. The lateral rib faces 78 which adjoin the rib crest 77ₙ run parallel and inclined with respect to one another. FIG. 33 in particular shows that one of the side edges 79 of the outer rib 76ₙ is assigned a plate-like, flat, square body 81 of small height. Moreover, the axial spacing y₂ of the outer ribs 76ₐ and 76ₙ from one another is in this case 4 mm.

The sleeve 70ₐ or 71 has a cylindrical sleeve interior 72 having an internal diameter k₁ of 6 mm, which merges into a hexagonal region 73ₐ or 73ₙ having an axial length y₁ of 6 mm. In the six corners thereof there run axis-parallel notched channels 66, as shown in FIG. 26. The resulting outer internal diameter k₃ of the hexagonal region 73ₐ or 73ₙ is 6.9 mm.

The clamping screw 84ₐ or 85 consists here in the installed state of a screw head 86 having an axial length z of 6 mm—with a hexagonal hole 87 at the end for an Allen key (not shown)—and of a continuous round shaft 88 having a length z₁ of in this case 29 or 30 mm; the thread 89 or 90 is cut into the shaft 88 over a length z₂ of 9 mm—preferably by rolling-shaping—only once the sleeve 70ₐ or 71 has been pushed onto the round shaft 88 until it comes to bear against the screw head 86. The distance of the thread 89 from the screw head 86, or the distance of an annular edge 92 of the thread 90 from the screw head 86 (said annular edge surrounding the shaft 88 in FIG. 30)—and thus the length of a round portion 88ₙ of the shaft 88—is denoted z₃ and in this case is 20 mm. Upon axial displacement of the clamping screw 85 in the assembly or tightening direction x of FIG. 31, this annular edge 92 strikes the inner face of the rear wall 94 of the sleeve 71, and this prevents removal of the clamping screw 86 from the sleeve 71. The rear wall 94 contains an opening 83 for the round shaft 88.

In FIG. 21, for reasons of clarity the sleeve 70ₐ is shown somewhat at a distance from the screw head 86; once the thread 89 has been formed, the clamping screw 86 can be displaced axially in the sleeve 70ₐ but cannot be completely removed on account of the thread 89; the external diameter q₁ of the latter is greater than the adjoining internal diameter k₁ of the sleeve interior 72.

The sleeve 70_{b} or 71 of FIGS. 25 to 27 differs from the sleeve 70ₐ of FIG. 22 by a collar 96 which is formed at one end, said collar having a height h₃ of for example 2 mm and an external diameter k₄ which at 8 mm is smaller than the external diameter k of the sleeve 70_{b} of 10.2 mm. This collar 96 increases the axial contact length g₃ of the sleeve 70_{b} with the clamping screw 84 to in this case 20.5 mm. As can be seen, the thread 89 of the latter runs outside the sleeve 70_{b}.

Moreover, in FIG. 31, for the sake of clarity, the clamping screw 85 is shown in its inner position in which it bears against the sleeve 71; the latter is again at a distance s of approximately 20 mm from the screw head 86. Once the thread 90 has been formed, the clamping screw 85 can be displaced axially in the sleeve 71 but cannot be completely removed on account of the thread 90 and its annular edge 92; as already mentioned, the external diameter q₁ thereof is greater than the diameter k₄ of said opening 83.

A collar 96 is likewise integrally formed at the end of the sleeve 71 which is remote from said rear wall 94, said collar 96 having a height h₃ of for example 2 mm and an external diameter k₅ which at 8 mm is smaller than the external diameter k of the sleeve 71 of 10.2 mm. As shown in FIGS. 30, 31, 33, this collar on one side delimits the peripheral surface 74 of the sleeve 71 and on the other side an annular zone 68 as sleeve edge; the collar 96 is made in one piece with the latter. This collar 96 increases the axial contact length y₃ of the sleeve 71 with the clamping screw 85 to in this case 20.5 mm.

1-37. (canceled)

38. A connection device comprising:
an extruded hollow profile (10) having a profile channel (12) and at least one undercut groove space (22) on a longitudinal groove (20) connected to another workpiece by a connection element selected from the group consisting of a screw element (50), a connecting member (50ₐ), a sleeve member (70, 70ₐ, 70_{b}) and combinations thereof, wherein the sleeve member (70, 70ₐ, 70_{b}) is inserted in the longitudinal groove (20) which comprises lateral outer ribs (76, 76ₐ, 76ₙ), wherein the lateral outer ribs (76, 76ₐ, 76ₙ) project from a peripheral surface (74) of the longitudinal groove (20) and the ribs can be inserted in radial grooves (82) of the hollow profile (10), wherein an interior (72) of the sleeve member (70ₐ, 70_{b}) has a cylindrical portion adjoined by a polygonal cross section (73ₐ) having notched channel (66) axis-parallel edges.

39. The device according to claim 38, wherein a clamping screw (84, 84ₐ) is inserted into an interior (72) of the sleeve member (70, 70ₐ, 70_{b}), wherein the clamping screw (84, 84ₐ) comprises a round shaft (88) integrally formed on the screw head (86), wherein the round shaft (88) merges into a coaxial screw shaft (90) at a distance (z₃) from the screw head (86).

40. The device according to claim 39, wherein an external diameter (q₁) of the thread (89) is greater than the internal diameter (k₁) of the sleeve interior (72) and wherein the external diameter (q₁) of the thread (89) is greater than the internal diameter (k₁) of the screw shaft (90).

41. The device according to claim 40, wherein the outer rib (76, 76ₐ, 76ₙ) is approximately triangular in cross section at least in its free end region and the outer rib (76, 76ₐ, 76ₙ) merges with its lateral rib faces (78) into shaped channels (75) of the sleeve peripheral surface (74), wherein the two rib faces (78) merge into a sharp edge rib crest (77ₙ).

42. The device according to claim 38, wherein the outer rib (76, 76ₐ, 76ₙ) has a side edge (7ₐ) at one end forming an angle (t) of approximately 45° with a radial line (Q) placed approximately through the centre of the outer rib.

43. The device according to claim 42, wherein the outer rib (76, 76ₐ, 76ₙ) is upset at its inclined side edge (79ₐ).

44. The device according to claim 38, wherein a plate-like, flat, square body (81) on a side edge (79) of the outer rib (76ₙ) engages axially over the outer ribs (76ₙ) on their rib face (78) remote from the collar (96) and/or the inclined side edge (79ₐ) of the outer rib (76, 76ₐ, 76ₙ) forms a contact resistance between the sleeve (70, 70ₐ, 70ₙ) and the associated radial grooves (82).

45. The device according to claim 38, wherein at least three groups (80) of outer ribs (76, 76ₐ, 76ₙ) are parallel to the centre axis (M) of the sleeve (71) and are assigned to radial grooves (82) in the fixing position, wherein a side edge (79, 79ₐ) of a group (80) of outer ribs (76, 76ₐ, 76ₙ) are aligned with one another parallel to the centre axis (M).

46. The device according to claim 38, wherein the radial grooves (82) are formed in the groove bottom (24) of the longitudinal groove (20) of the hollow profile (10) and wherein the radial groves (82) are formed in facing surfaces of shaped ribs (18) which delimit the longitudinal groove on the profile side face (16).
